(19) United States
(12) Patent Application Publication
(10) Pub. No.: US 2025/0154340 A1
(43) Pub. Date: May 15, 2025

(54) COMPOSITION CONTAINING NONLINEAR OPTICALLY ACTIVE COPOLYMER

(71) Applicant: NISSAN CHEMICAL CORPORATION, Tokyo (JP)

(72) Inventor: Tsubasa KASHINO, Funabashi-shi (JP)

(73) Assignee: NISSAN CHEMICAL CORPORATION, Tokyo (JP)

(21) Appl. No.: 18/832,983

(22) PCT Filed: Jan. 30, 2023
(86) PCT No.: PCT/JP2023/002908

§ 371 Date: Jul. 25, 2024

(30) Foreign Application Priority Data
Jan. 31, 2022 (JP) 2022-013062

(51) Int. Cl. C08K 5/101; C08F 220/18; C08F 222/40; C08J 5/18; G02F 1/361

(52) U.S. Cl. CPC C08K 5/101; C08F 220/1811; C08F 222/402; C08J 5/18; G02F 1/3617; C08F 2800/10; C08J 2333/10; C08J 2335/00

(57) ABSTRACT

A composition containing a nonlinear optically active copolymer, the composition including a solvent with which the nonlinear optically active copolymer is dissolved with high concentration and the composition obtained demonstrates good storage stability. A composition containing a nonlinear optically active copolymer, comprising a nonlinear optically active copolymer and a benzoate.

### TECHNICAL FIELD

The present invention relates to a composition containing a nonlinear optically active copolymer having an organic nonlinear optically active moiety, which is used in optical information processing and optical communication such as optical switching and optical modulation, and specifically, a composition in which the nonlinear optically active copolymer is dissolved at a high concentration.

### BACKGROUND ART

In recent years, in the fields of optical information processing, optical communication and the like, various optoelectronic elements using materials containing fluorescent dyes and nonlinear optical materials have been developed. Among these, nonlinear optical materials are materials that exhibit a polarization response that is proportional to the square, cube or higher-order terms of the magnitude of electrolysis caused by light, and those that exhibit a first-order electro-optic effect (Pockels effect), which is one of the second-order nonlinear optical effects, are being considered for application to optical switching, optical modulation, and the like.

In the related art, among nonlinear optical materials having the Pockels effect, inorganic nonlinear optical materials such as lithium niobate and potassium dihydrogen phosphate have already been put into practical use and are widely used. With the recent development of the information society, more advanced information processing is being required, compared to these inorganic materials, organic nonlinear optical materials, which have advantages such as higher nonlinear optical performance, lower material cost, and higher mass production, have been focused on, and active research and development is being conducted toward practical application.

As methods of producing a device using an organic material, a method using a single crystal of a compound having nonlinear optical properties (nonlinear optical compound), a vapor deposition method and an LB film method are known.

In addition, since polymer-based organic nonlinear optical materials such as a form in which a structure having nonlinear optical properties is introduced into the main chain or side chain of a polymer compound or a form in which a nonlinear optical compound is dispersed in a polymer matrix can be easily formed into a film by a casting method, a dipping method, a spin coating method or the like, they are useful in terms of ease of processing when devices are produced.

Among these polymer-based organic nonlinear optical materials, those in which a structure having nonlinear optical properties is introduced into the main chain or side chain of a polymer compound are expected to provide optically uniform properties because the nonlinear optical compound can be dispersed at a high concentration without aggregation. Regarding examples in which a structure having nonlinear optical properties is introduced into the main chain or side chain of such a polymer compound, a polymer compound in which a compound having very highly nonlinear optical properties is introduced into the side chain of methacrylate (Non-Patent Document 1) and an example in which, when monomers into which a structure having nonlinear optical properties and an acetylene group are introduced are self-crosslinked, it is expected to reduce the relaxation of orientation over time after orientation (poling) of the structure having nonlinear optical properties by applying an electric field (Patent Document 1) are known.

### PRIOR ART DOCUMENTS

### Patent Documents

Patent Document 1: JP 2003-301030 A

### Non-Patent Documents

Non-Patent Document 1: J. Polym. Sci. A: Polym. Chem., 49, p 47 (2011)

### SUMMARY OF THE INVENTION

### Problem to be Solved by the Invention

Since a nonlinear optically active copolymer in a form in which a structure having nonlinear optical properties (for example, a moiety having a nonlinear optically active dye) is introduced into the main chain or side chain of a polymer compound, is generally in the form of a solid powder, it can be dissolved in a solvent to form a varnish, and a film can be formed by a spin coating method or the like, and thus mounted onto an optoelectronic substrate. When optical elements that transmit light, such as optical waveguides, are formed, it is necessary to secure a certain degree of thickness. However, if the concentration of the nonlinear optically active copolymer dissolved in the solvent is low in a film formation process, it is difficult to obtain a sufficient film thickness, and it is not possible to obtain desired electro-optic properties.

In addition, due to the complexity of the structure, the nonlinear optically active dye often has a problem of long-term stability. Even if a nonlinear optically active copolymer incorporating a nonlinear optically active dye is dissolved in a solvent to form a uniform composition, the dye may gradually decompose in the solvent over time and the inherent nonlinear optical activity effect may gradually decrease. Therefore, it is desirable to consider the storage stability over time of a composition in which a nonlinear optically active copolymer is dissolved in a solvent.

As described above, while production of nonlinear optically active copolymers themselves and compounds have been proposed, there has been no proposal so far for a composition using a solvent that dissolves a nonlinear optically active copolymer at a high concentration and enables the composition to be obtained with excellent storage stability.

### Means for Solving the Problem

The inventors conducted extensive studies in order to achieve the above objects, and as a result, found that, when a benzoate is used as a solvent, it is possible not only to realize a composition in which a nonlinear optically active copolymer is dissolved at a high concentration of 20% by mass, but also to obtain a composition in which decomposition of a nonlinear optically active copolymer is curbed and which has excellent storage stability, and completed the present invention.

Specifically, the present invention provides, as a first aspect, a nonlinear optically active copolymer-containing composition comprising a nonlinear optically active copolymer and a benzoate,
as a second aspect, the nonlinear optically active copolymer-containing composition according to the first aspect, comprising 10% by mass or more of the nonlinear optically active copolymer,
as a third aspect, the nonlinear optically active copolymer-containing composition according to the first aspect or the second aspect, wherein the benzoate is at least one selected from the group consisting of methyl benzoate, ethyl benzoate, propyl benzoate, and isopropyl benzoate,
as a fourth aspect, the nonlinear optically active copolymer-containing composition according to any one of the first aspect to the third aspect, wherein the nonlinear optically active copolymer contains, in the same molecule, at least one or both of a repeating unit A1 of Formula (1) and a repeating unit A2 of Formula (2), and a repeating unit B of Formula (3) having a nonlinear optically active moiety:

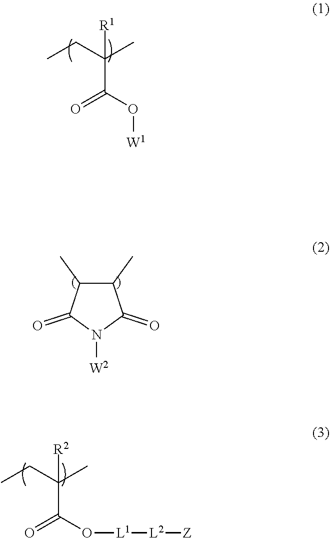

(in Formula (1),
R¹ is a hydrogen atom or a methyl group,
W¹ is a methyl group or —L³—R³,
L³ is a single bond, a C₁₋₃₀ divalent hydrocarbon group which arbitrarily contains an ether bond and/or an ester bond, or *—L⁴—NHC(═O)O— (* is a coupling end with respect to an O atom),
L⁴ is a C₁₋₃₀ divalent hydrocarbon group which arbitrarily contains an ether bond and/or an ester bond,
R³ is a C₁₋₆ alkyl group, a C₇₋₁₂ aralkyl group, a C₄₋₈ cycloalkyl group, a C₆₋₁₄ aliphatic crosslinked ring group, or a C₆₋₁₄ aryl group,
in Formula (2),
W² is a C₁₋₆ alkyl group, a C₇₋₁₂ aralkyl group, a C₄₋₈ cycloalkyl group, a C₆₋₁₄ aliphatic crosslinked ring group, or a C₆₋₁₄ aryl group,
in Formula (3),
R² is a hydrogen atom or a methyl group,
L¹ is a C₁₋₃₀ divalent hydrocarbon group which arbitrarily contains an ether bond and/or an ester bond,
L² is *—NHC(═O)O—, *—C(—O)NH—, or *—C(═O)O— (* is a coupling end with respect to L¹), and
Z is an atomic group that exhibits nonlinear optical activity),
   as a fifth aspect, the nonlinear optically active copolymer-containing composition according to the fourth aspect, wherein W² is a C₁₋₃ alkyl group, a C₇₋₁₀ aralkyl group, a C₆₋₈ cycloalkyl group, a C₈₋₁₂ aliphatic crosslinked ring group, or a C₆₋₁₀ aryl group,
   as a sixth aspect, the nonlinear optically active copolymer-containing composition according to the fourth aspect or the fifth aspect, wherein L² is *—NHC(═O)O— (* is a coupling end with respect to L¹),
   as a seventh aspect, the nonlinear optically active copolymer-containing composition according to any one of the fourth aspect to the sixth aspect, wherein Z is an atomic group having a furan ring group of Formula (4):

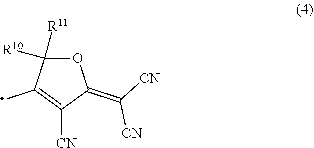

(wherein each of R¹⁰ and R¹¹ is independently a hydrogen atom, a C₁₋₅ alkyl group, a C₁₋₅ haloalkyl group, or a C₆₋₁₀ aryl group, and a black dot indicates a bond with the remaining structure constituting an atomic group Z that exhibits nonlinear optical activity),
   as an eighth aspect, the nonlinear optically active copolymer-containing composition according to the seventh aspect, wherein Z is an atomic group having a structure of Formula (5) or Formula (6) (in Formula (5) and Formula (6), one hydrogen atom is removed from any of R⁴ to R⁹),

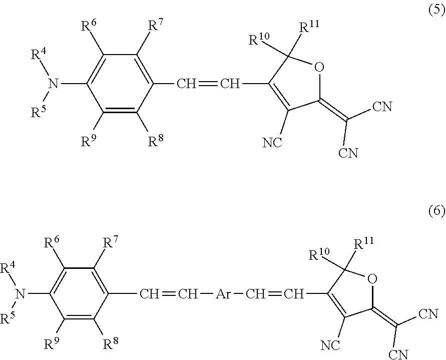

(wherein each of R⁴ and R⁵ is independently a hydrogen atom, a C₁₋₁₀ alkyl group which arbitrarily has a substituent, or a C₆₋₁₀ aryl group which arbitrarily has a substituent, each of R⁶ to R⁹ is independently a hydrogen atom, a C₁₋₁₀ alkyl group, a hydroxy group, a C₁₋₁₀ alkoxy group, a C₂₋₁₁ alkylcarbonyloxy group, a C₄₋₁₀ aryloxy group, a C₅₋₁₁ arylcarbonyloxy group, a silyloxy group having a C₁₋₆ alkyl group and/or a phenyl group,
or a halogen atom,
each of R¹⁰ and R¹¹ independently has the same meanings as defined above, and
Ar is a divalent aromatic group of Formula (7) or Formula (8)):

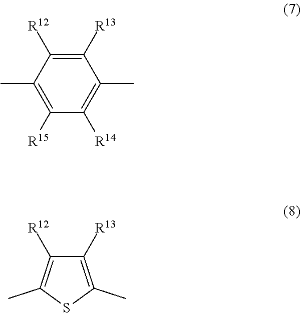

(wherein each of R¹² to R¹⁷ is independently a hydrogen atom, a C₁₋₁₀ alkyl group which arbitrarily has a substituent, or a C₆₋₁₀ aryl group which arbitrarily has a substituent),
   as a ninth aspect, the nonlinear optically active copolymer-containing composition according to the eighth aspect, wherein Z is an atomic group having a structure of Formula (5) or Formula (6) (in Formula (5) and Formula (6), one hydrogen atom is removed from either R⁴ or R⁵), and
   as a tenth aspect, an electro-optic element comprising a thin film obtained from the nonlinear optically active copolymer-containing composition according to any one of the first aspect to the ninth aspect.

### Effects of the Invention

According to the present invention, when a benzoate is used in a nonlinear optically active copolymer-containing composition, it is possible to provide a uniform composition in which the dissolved copolymer is not deposited or precipitated even in a form in which the nonlinear optically active copolymer is contained at a concentration of 10% by mass or more. Accordingly, the composition of the present invention, which can contain a nonlinear optically active copolymer at a high concentration, allows the thickness of a film formed from the composition to be controlled to be within a film thickness at which the performance derived from the nonlinear optically active copolymer can be sufficiently exhibited.

In addition, according to the present invention, it is possible to provide a composition having excellent storage stability by using a benzoate. That is, the composition of the present invention can be provided as a composition in which decomposition of a nonlinear optical dye in the nonlinear optically active copolymer even after long-term storage is curbed and which can retain nonlinear optical quality for a long time.

### BRIEF DESCRIPTION OF THE DRAWINGS

FIG. 1 is a diagram showing the change in wavelength of the absorption spectrum over a storage period.

FIG. 2 is a diagram showing the change in wavelength of the absorption spectrum over a storage period.

FIG. 3 is a diagram showing the change in wavelength of the absorption spectrum over a storage period.

FIG. 4 is a diagram showing the change in wavelength of the absorption spectrum over a storage period.

FIG. 5 is an observation image obtained using a digital microscope, showing a cross section of a film formed from a nonlinear optically active copolymer-containing composition formed on a silicon wafer.

### MODES FOR CARRYING OUT THE INVENTION

As described above, when optical elements are formed using optical materials, it is necessary to secure a certain degree of thickness in order to achieve light transmission as in, for example, optical waveguides. When an optical element is produced from a nonlinear optically active copolymer-containing composition according to the present invention by a film formation technique such as spin coating, although it depends on the molecular weight of the copolymer used, the viscosity of the composition and the like, it is difficult to secure a required film thickness unless the composition has a copolymer content of a certain level or more.

On the other hand, for the composition containing a nonlinear optically active copolymer incorporating a nonlinear optical dye, it is desirable to exhibit little decomposition of the nonlinear optical dye over time and high storage stability.

Accordingly, various solvents to be used in the composition have been examined in order to achieve a high concentration of the nonlinear optically active copolymer and storage stability of the composition, and as a result, the inventors found for the first time that there is a tradeoff relationship in many solvents between the high solubility of the nonlinear optically active copolymer and the storage stability of the composition. Then, the inventors conducted additional examination, and as a result, found that a benzoate solvent is a unique solvent that can eliminate this tradeoff, dissolves a nonlinear optically active copolymer at a high concentration, and allows a composition having excellent storage stability to be realized.

The present invention provides a nonlinear optically active copolymer-containing composition containing a nonlinear optically active copolymer and a benzoate, and the present invention will be described below in more detail.

### Benzoate

In the composition of the present invention, a benzoate is used as a solvent.

Examples of benzoates include methyl benzoate, ethyl benzoate, propyl benzoate, and isopropyl benzoate.

Here, solvents other than benzoate may be used in combination as long as the effects of the present invention are not impaired.

Here, most of the benzoates exemplified above are compounds having a boiling point of 100° C. or higher, and as will be described below, such compounds can be preferably used because, when a thin film is formed using the composition of the present invention, evaporation of the solvent during film formation can be minimized and paint defects can be minimized.

### Nonlinear Optically Active Copolymer

The nonlinear optically active copolymer (hereinafter simply referred to as a “copolymer”) used in the composition of the present invention is not particularly limited, and examples thereof include polymers having a structure of an organic dye compound that exhibits second-order nonlinear optical properties as a nonlinear optically active moiety.

Examples of such copolymers include copolymers disclosed in JP 2015-178544 A and nonlinear optically active copolymers disclosed in WO 2017/159815. In addition, examples of organic dye compounds include chromophores having nonlinear optical activity disclosed in WO 2011/024774.

As an example of the nonlinear optically active copolymer, a nonlinear optically active copolymer that contains, in the same molecule, at least one or both of a repeating unit Al of Formula (1) and a repeating unit A2 of Formula (2), and a repeating unit B of Formula (3) having a nonlinear optically active moiety may be exemplified.

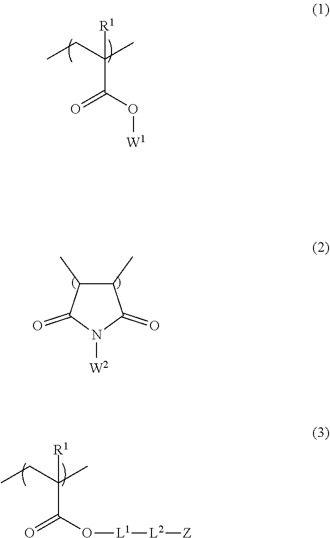

In Formula (1), R¹ is a hydrogen atom or a methyl group.

In Formula (1), W¹ is a methyl group or —L³—R³.

L³ is a single bond, a C₁₋₃₀ divalent hydrocarbon group which arbitrarily contains an ether bond and/or an ester bond, or *—L⁴—NHC(═O)O— (* is a coupling end with respect to an O atom), and L⁴ is a C₁₋₃₀ divalent hydrocarbon group which arbitrarily contains an ether bond and/or an ester bond.

Here, the C₁₋₃₀ divalent hydrocarbon group may be either an aliphatic group or an aromatic group, the aliphatic group may be any of linear, branched, and cyclic groups, and may be either a monocyclic ring or a condensed ring (a bicyclo ring, a tricyclo ring, etc.).

Examples of such C₁₋₃₀ divalent hydrocarbon groups include linear aliphatic groups such as a methylene group, ethylene group, trimethylene group, tetramethylene group, pentamethylene group, hexamethylene group, octane-1,8-diyl group, decane-1,10-diyl group, icosane-1,20-diyl group, and triacontane-1,30-diyl group; branched aliphatic groups such as a methylethylene group, 1-methyltrimethylene group, and 2,2-dimethyltrimethylene group; cycloaliphatic groups such as a cyclopentane-1,3-diyl group, cyclohexane-1,4-diyl group, tricyclo[5.2.1.0^{2,6}]decanediyl group, adamantanediyl group, norbomanediyl group, and norbornenediyl group; and aromatic groups such as a phenylene group and naphthalenediyl group.

R³ is a C₁₋₆ alkyl group, a C₇₋₁₂ aralkyl group, a C₄₋₈ cycloalkyl group, a C₆₋₁₄ aliphatic crosslinked ring group, or a C₆₋₁₄ aryl group.

Here, the C₁₋₆ alkyl group may have a branched structure, and examples thereof include methyl group, ethyl group, n-propyl group, isopropyl group, n-butyl group, isobutyl group, sec-butyl group, tert-butyl group, n-pentyl group, neopentyl group, and n-hexyl group.

Examples of C₇₋₁₂ aralkyl groups include phenyl methyl group (benzyl group), 2-phenylethyl group, 3-phenyl-n-propyl group, 4-phenyl-n-butyl group, 5-phenyl-n-pentyl group, and 6-phenyl-n-hexyl group, but the present invention is not limited thereto.

Examples of C₄₋₈ cycloalkyl groups include cyclobutyl group, cyclopentyl group, cyclohexyl group, cycloheptyl group, and cyclooctyl group.

The C₆₋₁₄aliphatic crosslinked ring group may have an unsaturated double bond, and examples thereof include isobornyl group, dicyclopentanyl group, dicyclopentenyl group, and adamantyl group, and groups in which these crosslinked ring groups are bonded to a C₁₋₄ alkyl group may also be used.

Here, examples of C₆₋₁₄ aryl groups include phenyl group, tolyl group, xylyl group, naphthyl group, anthryl group, and phenanthryl group.

In Formula (2), W² is a C₁₋₆ alkyl group, a C₇₋₁₂ aralkyl group, a C₄₋₈ cycloalkyl group, a C₆₋₁₄ aliphatic crosslinked ring group, or a C₆₋₁₄ aryl group. Specific examples of these groups include groups exemplified as R³ in Formula (1).

Among these, W² is preferably a C₁₋₃ alkyl group, a C₇₋₁₀ aralkyl group, a C₆₋₈ cycloalkyl group, a C₈₋₁₂ aliphatic crosslinked ring group, or a C₆₋₁₀ aryl group, and among these, an ethyl group, a phenyl methyl group (benzyl group), a cyclohexyl group, an adamantyl group, or a phenyl group is preferable, and W² is particularly preferably a cyclohexyl group.

In Formula (3), R² is a hydrogen atom or a methyl group.

In Formula (3), L¹ is a C₁₋₃₀ divalent hydrocarbon group which arbitrarily contains an ether bond and/or an ester bond.

Here, the C₁₋₃₀ divalent hydrocarbon group may be either an aliphatic group or an aromatic group, and the aliphatic group may be any of linear, branched, and cyclic groups. Among these, an aliphatic group is preferable, and a C₁₋₆ alkylene group is more preferable.

Examples of such C₁₋₃₀ divalent hydrocarbon groups include groups exemplified above for L³ and L⁴.

In Formula (3), L² is *—NHC(═O)O—, *—C(═O)NH— or *—C(═O)O— (* is a coupling end with respect to L¹).

Among these, L² is preferably *—NHC(═O)O— (* is a coupling end with respect to L¹).

In Formula (3), Z is an atomic group that exhibits nonlinear optical activity.

The atomic group that exhibits nonlinear optical activity refers to an atomic group derived from an organic nonlinear optical compound. The organic nonlinear optical compound is a π-conjugated compound having an electron donating group at one end of a π-conjugated chain and an electron withdrawing group at the other end, and is desirably one having a large molecular hyperpolarizability β. Examples of electron donating groups include a dialkylamino group, and examples of electron withdrawing groups include a cyano group, a nitro group, and a fluoroalkyl group.

Among these, in the present invention, preferable atomic groups that exhibit nonlinear optical activity include, for example, an atomic group having a furan ring group of the following Formula (4).

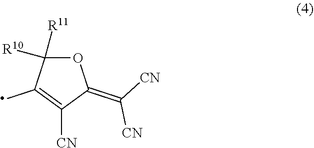

In the formula, each of R¹⁰ and R¹¹ is independently a hydrogen atom, a C₁₋₅ alkyl group, a C₁₋₅ haloalkyl group, or a C₆₋₁₀ aryl group, and a black dot (•) indicates a bond with the remaining structure constituting an atomic group Z that exhibits nonlinear optical activity.

Specific examples of preferable atomic groups (Z) that exhibit the nonlinear optical activity include an atomic group having a functional group derived from a structure of the following Formula (5) and an atomic group having a functional group derived from a structure of the following Formula (6). That is, the atomic group (Z) is preferably an atomic group having a structure of Formula (5) or Formula (6) (in these chemical formulae, one hydrogen atom is removed from any of R⁴ to R⁹).

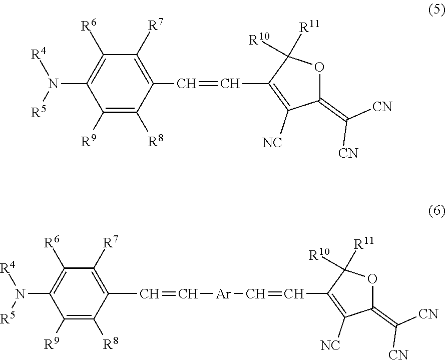

In Formula (5) or Formula (6), each of R⁴ and R⁵ is independently a

hydrogen atom, a C₁₋₁₀ alkyl group which arbitrarily has a substituent, or a C₆₋₁₀ aryl group which arbitrarily has a substituent.

Here, the C₁₋₁₀ alkyl group may have a branched structure or cyclic structure, and may also be an arylalkyl group (aralkyl group). Specific examples thereof include methyl group, ethyl group, n-propyl group, isopropyl group, cyclopropyl group, n-butyl group, isobutyl group, sec-butyl group, tert-butyl group, n-pentyl group, neopentyl group, cyclopentyl group, n-hexyl group, cyclohexyl group, n-octyl group, n-decyl group, 1-adamantyl group, benzyl group, and phenethyl group.

Examples of C₆₋₁₀ aryl groups include phenyl group, tolyl group, xylyl group, and naphthyl group.

Examples of substituents include amino groups; hydroxy groups; carboxy groups; epoxy groups; alkoxycarbonyl groups such as a methoxycarbonyl group and tert-butoxycarbonyl group; silyloxy groups such as a trimethylsilyloxy group, tert-butyldimethylsilyloxy group, tert-butyldiphenylsilyloxy group, and triphenylsilyloxy group; and halogen atoms such as fluorine atoms (fluoro group), chlorine atoms (chloro group), bromine atoms (bromo group), and iodine atoms (iodo group).

Here, the bond of the atomic group (Z) is particularly preferably a bond obtained by removing a hydrogen atom from R⁴ or R⁵.

In Formula (5) or Formula (6), each of R⁶ to R⁹ is independently a hydrogen atom, a C₁₋₁₀ alkyl group, a hydroxy group, a C₁₋₁₀ alkoxy group, a C₂₋₁₁ alkylcarbonyloxy group, a C₄₋₁₀ aryloxy group, a C₅₋₁₁ arylcarbonyloxy group, a silyloxy group having a C₁₋₆ alkyl group and/or a phenyl group, or a halogen atom.

Here, examples of C₁₋₁₀ alkyl groups include the groups exemplified above for R⁴ and R⁵.

Examples of C¹⁻¹⁰ alkoxy groups include groups in which the C₁₋₁₀ alkyl group is bonded via an oxygen atom.

Examples of C₂₋₁₁ alkylcarbonyloxy groups include groups in which the C₁₋₁₀ alkyl group is bonded via a carbonyloxy group.

Examples of C₄₋₁₀ aryloxy groups include phenoxy group, naphthalene-2-yloxy group, furan-3-yloxy group, and thiophene-2-yloxy group.

Examples of C₅₋₁₁ arylcarbonyloxy groups include benzoyloxy group, 1-naphthoyloxy group, furan-2-carbonyloxy group, and thiophene-3-carbonyloxy group.

Examples of silyloxy groups having a C₁₋₆ alkyl group and/or a phenyl group include trimethylsilyloxy group, tert-butyldimethylsilyloxy group, tert-butyldiphenylsilyloxy group, and triphenylsilyloxy group.

Examples of halogen atoms include fluorine atoms (fluoro group), chlorine atoms (chloro group), bromine atoms (bromo group), and iodine atoms (iodo group).

In Formula (5) or Formula (6), each of R¹⁰ and R¹¹ independently has the same meaning as R¹⁰ and R¹¹ in Formula (4), that is, is independently a hydrogen atom, a C₁₋₅ alkyl group, a C₁₋₅ haloalkyl group, or a C₆₋₁₀ aryl group.

Here, the C₁₋₅ alkyl group may have a branched structure or cyclic structure, and examples thereof include methyl group, ethyl group, n-propyl group, isopropyl group, cyclopropyl group, n-butyl group, isobutyl group, sec-butyl group, tert-butyl group, cyclobutyl group, n-pentyl group, neopentyl group, and cyclopentyl group.

The C₁₋₅ haloalkyl group may have a branched structure or cyclic structure, and examples thereof include fluoromethyl group, trifluoromethyl group, bromodifluoromethyl group, 2-chloroethyl group, 2-bromoethyl group, 1,1-difluoroethyl group, 2,2,2-trifluoroethyl group, 1,1,2,2-tetrafluoroethyl group, 2-chloro-1,1,2-trifluoroethyl group, pentafluoroethyl group, 3-bromopropyl group, 2,2,3,3-tetrafluoropropyl group, 1,1,2,3,3,3-hexafluoropropyl group, 1,1,1,3,3,3-hexafluoropropan-2-yl group, 3-bromo-2-methylpropyl group, 2,2,3,3-tetrafluorocyclopropyl group, 4-bromobutyl group, perfluoropentyl group, and perfluorocyclopentyl group.

Examples of C₆₋₁₀ aryl groups include phenyl group, tolyl group, xylyl group, and naphthyl group.

In Formula (5) or Formula (6), Ar is a divalent aromatic group of the following Formula (7) or Formula (8).

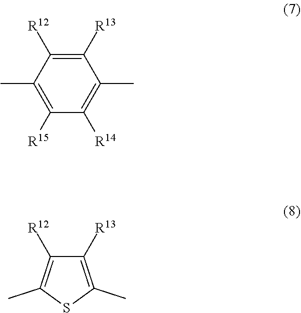

In Formula (7) and Formula (8), each of R¹² to R¹⁷ is independently a hydrogen atom, a C₁₋₁₀ alkyl group which arbitrarily has a substituent, or a C₆₋₁₀ aryl group which arbitrarily has a substituent.

Here, examples of C₁₋₁₀ alkyl groups, C₆₋₁₀ aryl groups, and substituents include the groups exemplified above for R⁴ and R⁵.

In addition, the nonlinear optically active copolymer according to the present invention may contain other repeating units (referred to as other repeating units) in addition to the repeating unit A1 of Formula (1), the repeating unit A2 of Formula (2), and the repeating unit B of Formula (3) having a nonlinear optically active moiety.

For example, in order to adjust the content of the nonlinear optically active moiety, a repeating unit forming a polymer matrix can be introduced into the nonlinear optically active copolymer. In addition, in order to contribute to improving the solvent resistance and reducing orientation relaxation in a molded component (cured film) obtained from the copolymer, and additionally, in order to enable a molded component to be formed by thermosetting, a repeating unit having a thermosetting (crosslinkable) structure can be introduced into the nonlinear optically active copolymer.

Regarding such other repeating units, in consideration of using the nonlinear optically active copolymer-containing composition of the present invention as an optically active material, for example, as a core of an optical waveguide, it is desirable to select one having a structure that does not have a large adverse effect on the transparency and moldability of the copolymer.

Regarding the repeating unit forming the polymer matrix, examples of polymer matrices include resins such as a polycarbonate, polystyrene, silicone resin, epoxy resin, polysulfone, polyethersulfone, and polyimide.

When such a repeating unit forming a polymer matrix is introduced into the nonlinear optically active copolymer, the nonlinear optical active copolymer according to the present invention may be in a form in which the repeating unit A1 of Formula (1) and/or the repeating unit A2 of Formula (2), the repeating unit B of Formula (3) having a nonlinear optically active moiety, and the repeating unit of the polymer matrix are copolymerized in practice.

In the repeating unit having a thermosetting (crosslinkable) structure, preferable examples of those having a thermosetting (crosslinkable) structure include an isocyanate group protected with a blocking agent. The blocking agent is not particularly limited as long as it can be dissociated (deblocked) by heating to reproduce an active isocyanate group, and examples thereof include phenols such as phenol, o-nitrophenol, p-chlorophenol, and o-, m- or p-cresol; alcohols such as methanol, ethanol, isopropanol, n-butanol, 2-ethoxyhexanol, 2-N,N-dimethylaminoethanol, 2-ethoxyethanol, and cyclohexanol; active methylene group-containing compounds such as dimethyl malonate, diethyl malonate, and methyl acetoacetate; oximes such as acetone oxime, methyl ethyl ketone oxime, methyl isobutyl ketone oxime, cyclohexanone oxime, acetophenone oxime, and benzophenone oxime; lactams such as ε-caprolactam; pyrazoles such as pyrazole, 3,5-dimethylpyrazole, and 3-methylpyrazole; and thiols such as dodecanethiol and benzenethiol.

Examples of repeating units having a thermosetting (crosslinkable) structure include a repeating unit of the following Formula (9).

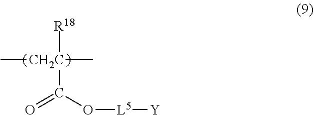

In Formula (9), R¹⁸ is a hydrogen atom or a methyl group, L⁵ is a C₁₋₃₀ divalent hydrocarbon group which arbitrarily contains an ether bond and/or an ester bond, and Y is an isocyanate group protected with a blocking agent.

Examples of C₁₋₃₀ divalent hydrocarbon groups for L⁵ include the same groups as those exemplified for L¹, L³ and L⁴.

The average molecular weight of the nonlinear optically active copolymer containing at least one or both of the repeating unit A1 of Formula (1) and the repeating unit A2 of Formula (2), and the repeating unit B of Formula (3) according to the present invention is not particularly limited, and for example, those having a weight average molecular weight of 10,000 to 1,000,000 are preferably exemplified.

Here, the weight average molecular weight in the present invention is a value measured through gel permeation chromatography (in terms of polystyrene).

In the nonlinear optically active copolymer according to the present invention, the repeating unit proportion of the repeating unit A1 of Formula (1) or the repeating unit A2 of Formula (2) in the same molecule (a total proportion when both the repeating unit A1 and the repeating unit A2 are contained) is not particularly limited, and it may be, for example, a proportion of 1 to 99 mol % or a proportion of 20 to 80 mol %.

In the nonlinear optically active copolymer according to the present invention, the mixing ratio of the repeating unit A1 of Formula (1) or the repeating unit A2 of Formula (2) (a total proportion when both the repeating unit A1 and the repeating unit A2 are contained), and the repeating unit B of Formula (3) is not particularly limited, and the mixing ratio may be, for example, A1+A2:B=99:1 to 1:99, 90:10 to 10:90, 80:20 to 20:80, 70:30 to 40:60, 60:40 to 40:60, or 60:40 to 50:50.

In addition, when the copolymer contains other repeating units, the mixing ratio of the repeating unit A1 of Formula (1) or the repeating unit A2 of Formula (2) (a total proportion when both the repeating unit A1 and the repeating unit A2 are contained), and other repeating units is not particularly limited, and the mixing ratio (in terms of molar ratio) may be, for example, A1+A2:other repeating units=99:1 to 10:90, 80:20 to 10:90, 75:25 to 10:90, or 60:40 to 10:90. In addition, in this case, the ratio of the total number of moles of the repeating unit A1 of Formula (1) or the repeating unit A2 of Formula (2) (a total proportion when both the repeating unit A1 and the repeating unit A2 are contained) and other repeating units (A1+A2+others) to the number of moles of the repeating unit B of Formula (3) is preferably the above ratio.

### Method of Producing Nonlinear Optically Active Copolymer

The nonlinear optically active copolymer containing at least one or both of the repeating unit A1 of Formula (1) and the repeating unit A2 of Formula (2), and the repeating unit B of Formula (3) in the same molecule can be obtained, for example, by copolymerizing (meth)acrylic acid derivatives having methyl (meth)acrylate or a C₁₋₁₂ hydrocarbon group such as an adamantyl group and/or N-substituted maleimide, and (meth)acrylic acid derivatives having functional groups into which a nonlinear optically active moiety can be introduced, and then reacting the functional group with a compound having a nonlinear optically active moiety. Examples of functional groups for introducing a desired moiety include isocyanate group, hydroxy group, carboxy group, epoxy group, amino group, halogenated allyl group, and halogenated acyl group, and in the present invention, preferably, a nonlinear optically active moiety is introduced by an isocyanate group to obtain a repeating unit B of Formula (3).

For example, the nonlinear optically active copolymer of the present invention can be produced by reacting the (meth)acrylic acid derivatives having methyl (meth)acrylate or a C₁₋₁₂ hydrocarbon group and/or N-substituted maleimide, and (meth)acrylic acid derivatives having an isocyanate group, and then reacting them with a compound having a functional group that can react with an isocyanate group and a nonlinear optically active moiety in the same molecule.

The functional group that can react with an isocyanate group is not particularly limited, and examples thereof include groups having active hydrogen such as a hydroxy group, an amino group, and a carboxy group and epoxy groups that can generate active hydrogen. In addition, examples of nonlinear optically active moieties include moieties derived from the organic nonlinear optical compound exemplified in the above description of Z (an atomic group that exhibits nonlinear optical activity) in Formula (3). A moiety having a furan ring group of Formula (4) is preferable.

Examples of compounds having a functional group that can react with an isocyanate group and a nonlinear optically active moiety in the same molecule include the compound of Formula (5) and the compound of Formula (6), and the repeating unit B of Formula (3) can be obtained by reacting a hydroxy group or the like present in this compound with an isocyanate group.

### Nonlinear Optically Active Copolymer-Containing Composition

The nonlinear optically active copolymer-containing composition according to the present invention essentially contains the nonlinear optically active copolymer and a benzoate, and may further contain other components.

In the composition, the content of the nonlinear optically active copolymer is preferably 10% by mass or more, and the upper limit thereof is not particularly limited, and it may be, for example, 30% by mass or less in consideration of operability of the composition. Although it depends on the molecular weight of the copolymer used and the viscosity of the solvent or the composition itself, when a composition contains a nonlinear optically active copolymer at a concentration of about 10% by mass or more, that is, when a nonlinear optically active copolymer is dissolved at a concentration of about 10% by mass or more, a sufficient film thickness can be secured when a film is formed by a spin coating method or the like to form an optical element (such as an optical waveguide) that transmits light.

The proportion of the solid content in the composition with respect to the total mass of the composition is, for example, 0.5 to 30% by mass, or for example, 5 to 30% by mass. Here, the solid content refers to all components (a nonlinear optically active copolymer and, if desired, additives to be described below) excluding a benzoate (solvent component) (when containing a solvent other than the benzoate, excluding the solvent) from the composition.

The nonlinear optically active copolymer-containing composition can be produced by mixing the nonlinear optically active copolymer, a benzoate, and if desired, other components. When the composition is prepared, heating may be performed appropriately as long as the components do not decompose or deteriorate.

In addition, the prepared composition is preferably used after being filtered using a filter with a pore size of about 0.2 μm.

The nonlinear optically active copolymer-containing composition of the present invention may contain, as necessary, antioxidants such as hydroquinone, UV absorbing agents such as benzophenone, rheology adjusting agents such as silicone oil and surfactants, adhesive auxiliary agents such as silane coupling agents, polymer matrix crosslinking agents, compatibilizing agents, curing agents, pigments, storage stabilizing agents, antifoaming agents and the like as long as the effects of the present invention are not impaired.

### Organic Nonlinear Optical Material

When the nonlinear optically active copolymer-containing composition of the present invention is used as an (organic) nonlinear optical material, it is generally used in the form of a thin film.

As the method of producing the thin film, a wet coating method in which the nonlinear optically active copolymer-containing composition of the present invention is applied onto an appropriate substrate (for example, a silicon/silicon dioxide-coated substrate, a silicon nitride substrate, a substrate coated with a metal, for example, aluminum, molybdenum, or chromium, a glass substrate, a quartz substrate, an ITO substrate, etc.) or a base such as a film (for example, a resin film such as a triacetyl cellulose film, a polyester film, and an acrylic film) by spin coating, flow coating, roll coating, slit coating, spin coating following slit, inkjet coating, printing or the like to form a film is preferable.

Here, in the nonlinear optically active copolymer, for example, when the repeating unit of Formula (9) is contained as another repeating unit, the thin film (molded component) formed from the composition of the present invention can be thermally cured (crosslinked). Specifically, when heated, the blocking agent protecting the isocyanate groups dissociates (is deblocked), active isocyanate groups are thus reproduced, and the active isocyanate groups react with each other or with other curing agents (crosslinking agents) and are cured (crosslinked).

The curing (crosslinking) temperature is not particularly limited as long as it is a temperature at which the blocking agent protecting the isocyanate groups dissociates, and is in a range of generally 100 to 300° C., preferably 120 to 250° C., and more preferably 140 to 200° C.

### Electro-Optic Element and Optical Switching Element

The nonlinear optically active copolymer-containing composition of the present invention can be applied as a material for various electro-optic elements proposed in the related art. For example, the electro-optic element containing the thin film obtained from the nonlinear optically active copolymer-containing composition of the present invention is also an object of the present invention.

Examples of typical electro-optic elements include optical switching elements (optical communication elements) such as a Mach-Zehnder type optical modulator. In the optical switching element, the nonlinear optically active copolymer-containing composition of the present invention is applied onto a base such as glass or plastic and then processed by a lithography method using light or an electron beam, a wet and dry etching method, a nanoimprinting method or the like to form an optical waveguide structure that can transmit light. Generally, the nonlinear optically active copolymer-containing composition is applied onto and laminated on a material having a smaller refractive index than the nonlinear optically active copolymer-containing composition to form an optical waveguide structure, but the present invention is not limited to this structure, and the nonlinear optically active copolymer-containing composition of the present invention can also be applied to other optical waveguide structures.

In a Mach-Zehnder type optical modulator which is a typical optical switching element, a high frequency voltage is applied to one or both of the branched optical waveguide structure to exhibit electro-optic properties, which change the refractive index and cause a phase shift in the propagating light. When the light intensity after branching and multiplexing is changed according to this phase shift, light can be modulated at a high speed.

In addition, the electro-optic element referred to here can not only be used for phase and intensity modulation but can also be used as, for example, a polarization conversion element, a demultiplexing and multiplexing element and the like.

In addition, the nonlinear optically active copolymer-containing composition of the present invention can also be used in applications such as an electric field sensor that detects a change in an electric field as a change in a refractive index in addition to communication element applications.

An optical waveguide using the nonlinear optically active copolymer-containing composition of the present invention as a core material can be produced, for example, by the method disclosed in WO 2016/035823.

In the present invention, in order to exhibit second-order nonlinear optical properties of a material (for example, a thin film) produced using the nonlinear optically active copolymer-containing composition, a poling treatment is required. The poling treatment is an operation in which a predetermined electric field is applied to a material when heated to a temperature that is approximately equal to or higher than the glass transition temperature of the material or equal to or lower than the melting point, the material is cooled while maintaining the electric field, and thus the nonlinear optically active moieties (an atomic group that exhibits nonlinear optical activity) contained in the copolymer are oriented. According to this operation, the material can exhibit macroscopic nonlinear optical properties.

In the present invention, if a thin film is simply formed from the nonlinear optically active copolymer-containing composition, the orientation of the nonlinear optically active moieties (an atomic group that exhibits nonlinear optical activity) becomes random, and thus heating is performed at a temperature that is 15° C. and preferably 10° C. lower than the glass transition temperature of the nonlinear optically active copolymer or higher (about 120° C. or higher when the nonlinear optically active copolymer does not exhibit a glass transition temperature) and equal to or lower than the melting point, and the poling treatment is performed to exhibit nonlinear optical properties.

### EXAMPLES

Hereinafter, the present invention will be described in more detail with reference to examples, but the present invention is not limited to the following examples.

Here, in the examples, devices and conditions used for preparing samples and analyzing physical properties are as follows.
(1) Gel permeation chromatography (GPC)
   Device: commercially available from Shimadzu Corporation
(GPC system configuration)
   System controller: CBM-20A
   Column oven: CTO-20A
   Auto-sampler: SIL-10AF
   Detector: SPD-20A and RID-10A
   Exhaust unit: DGU-20A3
   GPC column: Shodex (registered trademark) KF-804L and KF-803L
   Column temperature: 40° C.
   Solvent: tetrahydrofuran
   Flow rate: 1 mL/min
   Standard sample: five types of polystyrene with different weight average molecular weights (197,000, 55,100, 12,800, 3,950, and 1,260)
(2) ¹H NMR spectrum
   Device: Ascend™ 500 (commercially available from Bruker)
   Solvent: deuterated chloroform (CDCl₃)
   Internal standard: tetramethylsilane
(3) Ultraviolet-visible-near-infrared absorption spectrum
   Device: UV-3600 spectrophotometer (commercially available from Shimadzu Corporation)
   Solvent: tetrahydrofuran (THF)
   Cell: 1 cm-long quartz cell
   Measurement temperature: room temperature
   Measurement wavelength range: 800 nm to 300 nm (0.5 nm intervals)

The nonlinear optical compound used in the present invention was not particularly limited, and was selected from among, for example, organic dye compounds exhibiting second-order nonlinear optical properties. As the nonlinear optical compounds to be introduced into the side chain of the polymer, the following nonlinear compounds (1) and (2) were used.

### [Reference Example 1] Production of Nonlinear Optical Compound (1)

As the nonlinear optical compound (1) to be introduced into the side chain of the polymer, compounds [Z1] and [Z2] of the following formulae were used. The following compounds were produced by the same method as disclosed in X. Zhang et al., Tetrahedron Lett., 51, p 5823 (2010).

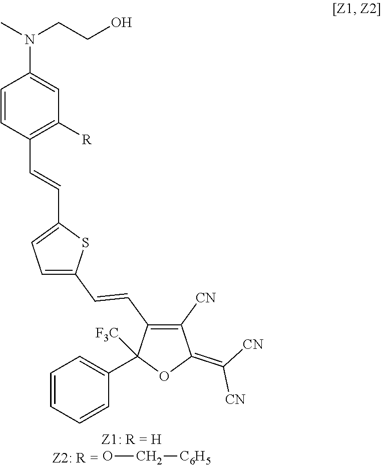

### [Reference Example 2] Production of Nonlinear Optical Compound (2)

As the nonlinear optical compound (2) to be introduced into the side chain of the polymer, a compound [Z3] of the following formula was used. The following compound was produced by the following method.

N-methyl-N-(2-hydroxyethyl)-4-aminobenzaldehyde (CAS No. 1201-91-8, commercially available from Combi-Blocks) was dissolved in ethanol, impurities were then filtered, and the sample was purified by reprecipitation with toluene.

8.96 g (50 mmol) of the purified N-methyl-N-(2-hydroxyethyl)-4-aminobenzaldehyde was dissolved in 50 mL of ethanol. Next, 15.76 g (50 mmol) of [3-cyano-4-methyl-5-phenyl-5-(trifluoromethyl)-2(5H)-furanylidene]-propanedinitrile was put into a round-bottom flask, and 350 mL of ethanol was added. The mixture was stirred in an oil bath at 65° C. until [3-cyano-4-methyl-5-phenyl-5-(trifluoromethyl)-2(5H)-furanylidene]-propanedinitrile was dissolved. After the dissolution, an ethanol solution of N-methyl-N-(2-hydroxyethyl)-4-aminobenzaldehyde was added a small drop at a time. After stirring for 1 hour, the reaction solution was cooled to room temperature and then stored in a refrigerator controlled at 4° C. for 1 day. The reaction solution was filtered with a filter, and the filtrate was washed with cold ethanol several times. The obtained filtrate was dried under a reduced pressure to obtain 22.86 g of a compound [Z3] with a yield of 96% and an LC purity of 99% or more. Here, [3-cyano-4-methyl-5-phenyl-5-(trifluoromethyl)-2(5H)-furanylidene]-propanedinitrile (CAS. No. 436097-14-2) which was synthesized with reference to W. Jin, P. V. Johnston, D. L. Elder, K. T. Manner, K. E. Garrett, W. Kaminsky, R. Xu, B. H. Robinson and L. R. Dalton, Journal of Materials Chemistry C, Issue 4, 2016, page 3119-3124 was used.

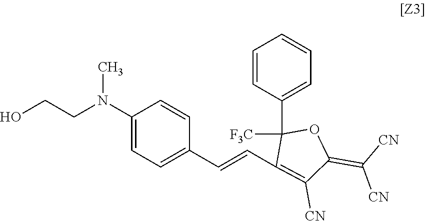 [SMILES: CN(CCO)c1ccc(/C=C/C2=C(C#N)C(=C(C#N)C#N)OC2(c2ccccc2)C(F)(F)F)cc1]

### [Production Example 1 and Production Example 2] Production of Nonlinear Optical Active Copolymers (EOP1 and EOP2)

### (1) Production of Precursor Polymer (Precursor of Nonlinear Optically Active Copolymer)

In a 300 mL round-bottom flask, 10 g (100 mmol) of methyl methacrylate, 29.37 g (133 mmol) of adamantyl methacrylate, 15.52 g (100 mmol) of 2-isocyanatoethyl methacrylate and 1.09 g (6.67 mmol) of 2,2′-azobis (isobutyronitrile) were dissolved in 125 g of dehydrated toluene, and the mixture was stirred under a nitrogen atmosphere at 80° C. for 5 hours. After cooling to room temperature (about 23° C.), this reaction mixture was added to 500 mL of hexane to precipitate a polymer. This precipitate was filtered and then dried at room temperature (about 23° C.) under a reduced pressure to obtain 50 g of a precursor polymer of the nonlinear optically active copolymer. The polymerization ratio of methyl methacrylate (MM), adamantyl methacrylate (AM) and 2-isocyanatoethyl methacrylate (NCO) in the precursor polymer was MM:AM:NCO=30 mol %:40 mol %:30 mol %, which was the same as the monomer preparation ratio, based on the proton ratio of ¹H NMR.

### (2) Production of Nonlinear Optically Active Copolymer

13.3 g (a preparation amount with respect to a total amount of the precursor polymer and the nonlinear optical compound (1): 40% by mass, 22.8 mmol) of the compound [Z1] as the nonlinear optical compound (1) was added to 20 g (containing about 35.5 mmol of isocyanate groups) of the obtained precursor polymer. Dry tetrahydrofuran (THF) was added thereto in an amount of 25 times the mass of the solid content, and the mixture was stirred and uniformly dissolved. 1.0 g ([commercially available from Tokyo Chemical Industry Co., Ltd.], 5% by mass with respect to the precursor polymer) of dibutyltin dilaurate (IV) was additionally added thereto. The mixture was stirred under an inert atmosphere at room temperature to cause a condensation reaction between the isocyanate group of the precursor polymer and the hydroxy group of the nonlinear optical compound (1). When the peak of the unreacted nonlinear optical compound (1) disappeared in GPC, methanol was added to react unreacted isocyanate groups.

After the reaction was completed, THF was concentrated and the polymer was precipitated with a large amount of methanol. The precipitate was collected by a filter and sufficiently dried to obtain a desired nonlinear optically active copolymer: EOP1 (Production Example 1) having a repeating unit of the following formula at a yield of about 90%.

In the same procedure as in Production Example 1, when the compound [Z2] instead of the compound [Z1] was used as the nonlinear optical compound (1) for production, a desired nonlinear optically active copolymer: EOP2 (Production Example 2) having a repeating unit of the following formula was obtained.

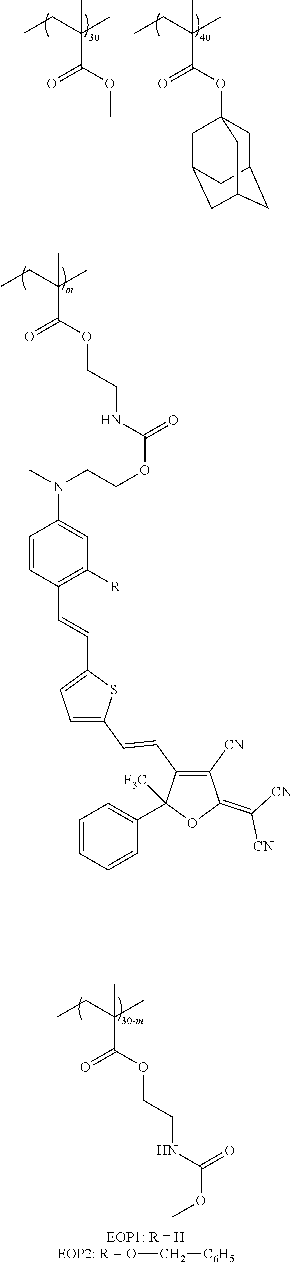

### [Production Example 3] Production of nonlinear optical active copolymer (EOP3)

### (1) Production of Nonlinear Optical Copolymer Precursor

In a 200 mL round-bottom flask, 5.38 g (30 mmol) of cyclohexylmaleimide, 4.65 g (30 mmol) of 2-isocyanatoethyl methacrylate, 0.039 g (0.24 mmol) of 2,2′-azobis (isobutyronitrile) and 0.21 g (0.6 mmol) of 2-cyano-2-propyldodecyl trithiocarbonate were dissolved in 40 g of dehydrated toluene, and the mixture was stirred under a nitrogen atmosphere at 80° C. for 12 hours. After cooling to room temperature (about 23° C.), this reaction mixture was added to 200 mL of hexane to precipitate a polymer. This precipitate was filtered and then dried at room temperature under a reduced pressure to obtain 9.0 g of a precursor polymer of the nonlinear optically active copolymer. The polymerization ratio of cyclohexylmaleimide (CM) and 2-isocyanatoethyl methacrylate (NCO) in the precursor polymer was CM:NCO=50mol %:50 mol %, which was the same as the monomer preparation ratio, based on the proton ratio of ¹H NMR.

### (2) Production of Nonlinear Optically Active Copolymer

5.33 g (a preparation amount with respect to a total amount of the precursor polymer and the nonlinear optical compound (2): 40% by mass, 11.1 mmol) of the compound [Z3] as the nonlinear optical compound (2) was added to 8 g (containing about 14.4 mmol of isocyanate groups) of each of the obtained precursor polymers. Dry THF was added thereto in an amount 25 times the mass of the solid content, and the mixture was stirred and uniformly dissolved. 0.4 g (5% by mass with respect to the precursor polymer) of dibutyltin dilaurate (IV) was additionally added thereto. The mixture was stirred under an inert atmosphere at room temperature to cause a condensation reaction between the isocyanate group of the precursor polymer and the hydroxy group of the nonlinear optical compound (2). When the peak of the unreacted nonlinear optical compound (2) disappeared in GPC, methanol was added to react unreacted isocyanate groups.

After the reaction was completed, THF was concentrated and the polymer was precipitated with a large amount of methanol. The precipitate was collected by a filter and sufficiently dried to obtain a desired nonlinear optically active copolymer: EOP3 (Production Example 3) having a repeating unit of the following formula at a yield of about 92%.

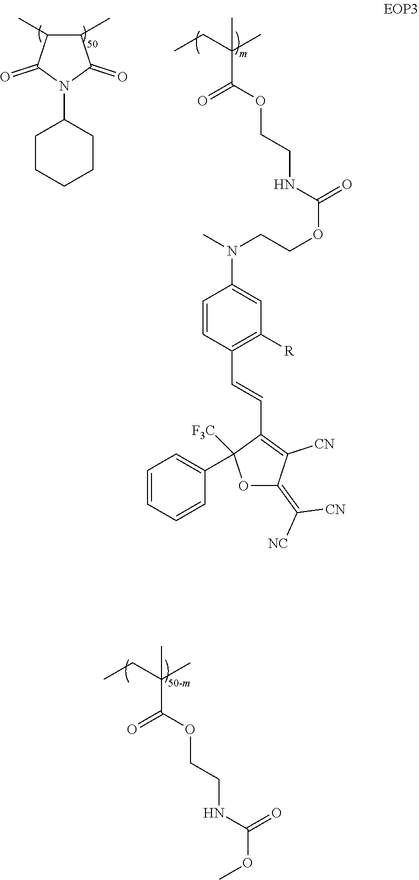

### Examples 1 to 2 and Comparative Examples 1 to 15

### (1) Evaluation of Solubility of Nonlinear Optically Active Copolymer (EOP1, EOP2 and EOP3) in Various Solvents

Regarding various solvents, the solubility of the nonlinear optically active copolymers (EOP1, EOP2 and EOP3) was confirmed.

0.5 g of each nonlinear optically active copolymer was put into a 100 mL round-bottom flask, and 2.0 g of each solvent shown in Table 1 was added dropwise thereto to prepare a solution with a copolymer concentration of 20% by mass. The solution was heated and stirred using an oil bath heated to 80° C. and a stirring bar. After heating and stirring for 30 minutes, it was visually confirmed whether the nonlinear optically active copolymer (EOP) was dissolved. The solution determined to be dissolved by visual observation was additionally passed through a 1.0 micrometer PTFE syringe filter, and the sample with no residue on the filter was finally recognized to be dissolved, and used as a nonlinear optically active copolymer-containing composition.

When the dissolved EOP residue was confirmed by visual observation or on the filter, the solution was diluted (EOP concentration 1/2) two-fold with the solvent used, then heated and stirred again (80° C., for 30 minutes), and the solubility was confirmed again by visual observation and by passing through the filter.

This operation was repeated, and the concentration [% by mass] of the nonlinear optically active copolymer when the nonlinear optically active copolymer was completely dissolved was evaluated as the solubility(S) of the solvent. For example, solvents in which complete dissolution of EOP was confirmed at an EOP concentration of 20% by mass were evaluated as having “a solubility of 20 or more [20≤S],” solvents in which complete dissolution of EOP was confirmed at an EOP concentration of 10% by mass were evaluated as having “a solubility of 10 or more and 20 or less [10≤S<20],” solvents in which complete dissolution of EOP was confirmed at an EOP concentration of 5% by mass were evaluated as having “a solubility of 5 or more and 10 or less [5≤S<10],” and solvents in which complete dissolution of EOP was confirmed at an EOP concentration of 2.5% by mass were evaluated as having “a solubility of 2.5 or more and 5 or less [2.5≤S<5].”

In addition, for solvents in which complete dissolution of EOP was not confirmed at an EOP concentration of 2.5% by mass, the EOP concentration was lowered to 1% by mass, solvents in which complete dissolution of EOP was confirmed at an EOP concentration of 1.0% by mass were evaluated as having “a solubility of 1 or more and 2.5 or less [1≤S<2.5],” and solvents in which even a small amount of dissolved EOP residue was observed at an EOP concentration of 1.0% by mass were evaluated as having “a solubility of less than 1 [<1].”

Table 1 shows the solubility of the solvents for the nonlinear optically active copolymers EOP1 to EOP3 prepared in the production examples.

### (2) Evaluation of Storage Stability of Compositions Containing Nonlinear Optically Active Copolymers (EOP1, EOP2 and EOP3)

(1) The storage stability of the compositions of nonlinear optically active copolymers (EOP1, EOP2 and EOP3) that were confirmed to be dissolved when passed through a filter in the solubility test was evaluated by an accelerated thermal stability test (stress test).

The obtained composition was put into a screw bottle with a lid, the lid was tightly closed, and the sample was stored in an incubator at 80° C. for 1 week. Immediately after preparation of the composition, and on the third and seventh days of storage after preparation, a small amount of the composition was sampled and diluted with THE to prepare a measurement sample. The UV-vis absorption spectrum of the measurement sample was measured.

In the obtained absorption spectrum, the maximum absorption wavelength of the nonlinear optically active dye of the measurement sample was standardized (normalized) to 1, the change in wavelength of the absorption spectrum over a storage period was evaluated based on the following criteria, and the storage stability of the compositions was evaluated. The obtained results are shown in Table 1.

### [Storage Stability Evaluation]

A: no to almost no spectrum change occurred
B: slight spectrum change occurred
C: clear spectrum change occurred
Z: spectrum change occurred to the extent that the original shape (immediately after the composition was prepared) was no longer retained

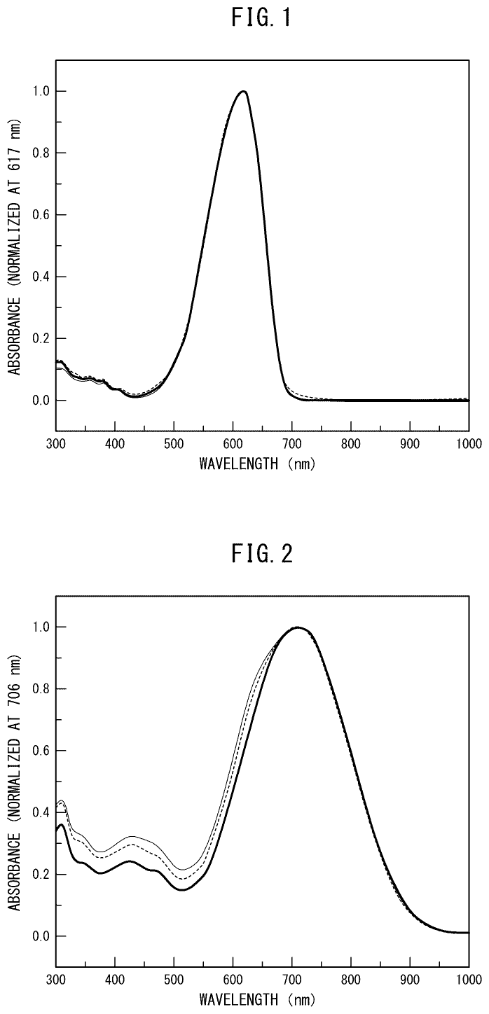

FIG. 1 to FIG. 4 show absorption spectrum diagrams serving as references for the evaluations A, B, C and Z. The maximum wavelength of the spectrum was unique to each dye, and generally, when a dye decomposed, the absorption at the maximum wavelength decreased, and the appearance of a new peak on the shorter wavelength side could be checked. In the drawings, the thick line indicates the spectrum immediately after the composition was prepared, the dotted line indicates the spectrum after 3 days of storage, and the thin line indicates the spectrum after 7 days of storage.

FIG. 1 is an example of evaluation A, showing the spectrum of Example 1: a composition of methyl benzoate and EOP3 (normalized at a maximum wavelength of 617 nm). As shown in FIG. 1, in this example, even after the storage period elapsed, almost no spectrum change occurred.

FIG. 2 is an example of evaluation B, showing the spectrum of Comparative Example 8: a composition of diethyl malonate and EOP1 (normalized at a maximum wavelength of 706 nm). In this example, it was confirmed that the absorbance slightly changed with respect to the reference (immediately after preparation: thick line) in wavelength ranges other than the maximum wavelength.

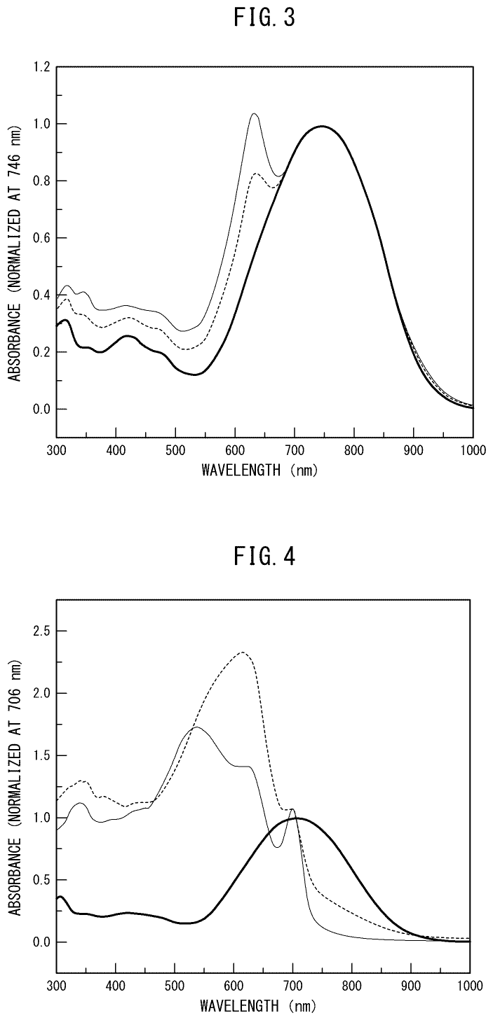

FIG. 3 is an example of evaluation C, showing the spectrum of Comparative Example 10: a composition of dimethyl maleate and EOP2 (normalized at a maximum wavelength of 746 nm). In this example, it was confirmed that a new peak appeared on the side of the wavelength shorter than the maximum wavelength (in this example, about 630 nm), and clear spectrum change occurred.

FIG. 4 is an example of evaluation Z, showing the spectrum of Comparative Example 3: a composition of N-methyl-2-pyrrolidone and EOP1 (normalized at a maximum wavelength of 706 nm). In this example, it was confirmed that, on the third day (dotted line) and the seventh day (thin line) of storage, change occurred to the extent that the original shape of the reference (immediately after preparation: thick line) spectrum was no longer retained.

As shown in FIG. 1 to FIG. 4, it could be determined that the composition with an evaluation A (FIG. 1) had the best storage stability, dye decomposition was more likely to occur as the composition was evaluated as B (FIG. 2) to C (FIG. 3), and the composition with an evaluation Z (FIG. 4) indicated that dye decomposition proceeded to such an extent that the waveform of the original dye was no longer discernible. In this evaluation. those up to the evaluation B were determined to be acceptable, and those with the evaluation C and the evaluation Z were determined to be unacceptable.

TABLE 1

| | | | Boiling | Solubility S*¹ | | | Storage stability | | |
|---|---|---|---|---|---|---|---|---|---|
| | | Solvent name | point [° C.] | EOP1 | EOP2 | EOP3 | EOP1 | EOP2 | EOP3 |
| Example | 1 | methyl benzoate | 200 | 20 ≤ S | 20 ≤ S | 20 ≤ S | A | B | A |
| | 2 | ethyl benzoate | 213 | 20 ≤ S | 20 ≤ S | 20 ≤ S | A | B | A |
| Comparative | 1 | dimethyl sulfoxide | 189 | 20 ≤ S | 20 ≤ S | 20 ≤ S | Z | Z | Z |
| Example | 2 | γ-valerolactone | 207 | 20 ≤ S | 20 ≤ S | 20 ≤ S | Z | Z | B |
| | 3 | N-methyl-2-pyrrolidone | 202 | 20 ≤ S | 20 ≤ S | 20 ≤ S | Z | Z | Z |
| | 4 | cyclohexanone | 156 | 20 ≤ S | 20 ≤ S | 20 ≤ S | Z | Z | Z |
| | 5 | cyclopentanone | 131 | 20 ≤ S | 20 ≤ S | 20 ≤ S | Z | Z | Z |
| | 6 | 4-methyl-2-pentanone | 116 | 10 ≤ S < 20 | 10 ≤ S < 20 | 10 ≤ S < 20 | B | Z | B |
| | 7 | 1,2-dichlorobenzene | 180 | 20 ≤ S | 20 ≤ S | 20 ≤ S | B | C | A |
| | 8 | diethyl malonate | 199 | 1.0 ≤ S < 2.5 | <1 | 1.0 ≤ S < 2.5 | B | C | A |
| | 9 | propylene glycol monomethyl ether acetate | 146 | 1.0 ≤ S < 2.5 | <1 | 1.0 ≤ S < 2.5 | A | C | A |
| | 10 | dimethyl maleate | 204 | <1 | <1 | <1 | B | C | A |
| | 11 | diethylene glycol butyl methyl ether | 212 | <1 | <1 | <1 | A | B | B |
| | 12 | butyl acetate | 126 | <1 | <1 | <1 | A | B | A |
| | 13 | 4-methoxytoluene | 175 | 1.0 ≤ S < 2.5 | <1 | 1.0 ≤ S < 2.5 | C | C | A |
| | 14 | 1,2,4-trichlorobenzene | 214 | 2.5 ≤ S < 5 | 2.5 ≤ S < 5 | 2.5 ≤ S < 5 | A | B | A |
| | 15 | 1,4-dioxane | 101 | <1 | <1 | <1 | B | B | B |

*¹EOP concentration at which dissolution was confirmed
20% by mass: 20 ≤ S
10% by mass: 10 ≤ S < 20
5% by mass: 5 ≤ S < 10
2.5% by mass: 2.5 ≤ S < 5
1% by mass: 1.0 ≤ S < 2.5
Less than 1% by mass: <1

As shown in Table 1, it was confirmed that the compositions of Example 1 and Example 2 using a benzoate solvent were compositions which allowed the nonlinear optically active copolymer to be dissolved at a concentration of 20% by mass, showed almost no dye decomposition in the storage stability evaluation according to a stress test at 80° C., and achieved both a high concentration and storage stability.

On the other hand, the results showed that the solvents of Comparative Example 1 to Comparative Example 7 generally could dissolve the nonlinear optically active copolymer at a high concentration, but promoted dye decomposition. In addition, the obtained results showed that the solvents of Comparative Example 8 to Comparative Example 15 could curb dye decomposition compared to the solvents of Comparative Example 1 to Comparative Example 7, but it was difficult to dissolve the nonlinear optically active copolymer at a high concentration.

### [Evaluation of Film Formation of Nonlinear Optically Active Copolymer-Containing Composition]

1.5 g of EOP1 was weighed out, and put into a screw tube together with 8.5 g of methyl benzoate. The mixture was sufficiently stirred to obtain a methyl benzoate solution containing 15% by mass of EOP1 (nonlinear optically active copolymer-containing composition). The obtained solution was filtered with a 1.0 μm PTFE syringe filter.

The nonlinear optically active copolymer-containing composition was added dropwise to a 4-inch silicon wafer, and a film was formed by spin coating using a spin coater (Cee 200CBX, commercially available from Brewer Science) at 1,500 rpm for 40 seconds. After the film formation, drying was performed on a hot plate at 100° C. for 2 minutes to obtain a film of EOP1.

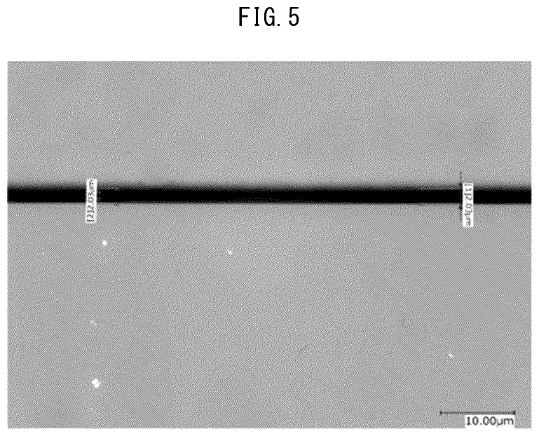

In order to confirm the film thickness and uniformity, a digital microscope (VHX-6000, commercially available from Keyence Corporation) was used for observation. A silicon wafer on which a film was formed from the composition containing EOP1 was cut to a width of 1 cm by hand, and placed vertically so that the cut surface could be observed. FIG. 5 shows an observation image obtained using a digital microscope. In FIG. 5, the lower side indicates the silicon wafer itself, and the black part located on the upper part indicates the formed film. When the cut surface was observed, a uniform film with a film thickness of about 2 μm was observed. Here, although it depends on the type and form of the optical element, for example, when used in an optical waveguide (single mode) or the like, it is desirable for the film to have a thickness of about 0.5 μm to 5 μm, but the film obtained from the nonlinear optically active copolymer-containing composition of the present invention could secure a sufficient film thickness.

As shown in the results of the examples above, it was found that the benzoate solvent was a solvent that could dissolve the nonlinear optically active copolymer at a high concentration, and also had an effect of realizing storage stability of the composition.

In addition, it was confirmed that a thin film formed from the composition could secure a film thickness sufficient to exhibit performance as an optical element.

1. A nonlinear optically active copolymer-containing composition comprising a nonlinear optically active copolymer and a benzoate.

2. The nonlinear optically active copolymer-containing composition according to claim 1, comprising 10% by mass or more of the nonlinear optically active copolymer.

3. The nonlinear optically active copolymer-containing composition according to claim 1,
wherein the benzoate is at least one selected from the group consisting of methyl benzoate, ethyl benzoate, propyl benzoate, and isopropyl benzoate.

4. The nonlinear optically active copolymer-containing composition according to claim 1,
wherein the nonlinear optically active copolymer contains, in the same molecule, at least
one or both of a repeating unit A1 of Formula (1) and a repeating unit A2 of Formula (2), and
a repeating unit B of Formula (3) having a nonlinear optically active moiety: 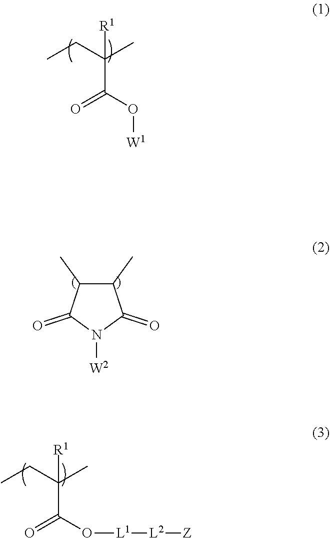
(in Formula (1),
R¹ is a hydrogen atom or a methyl group,
W′ is a methyl group or —L³—R³,
L³ is a single bond, a C₁₋₃₀ divalent hydrocarbon group which arbitrarily contains an ether bond and/or an ester bond, or *—L⁴—NHC(═O)O)— (* is a coupling end with respect to an O atom),
L⁴ is a C₁₋₃₀ divalent hydrocarbon group which arbitrarily contains an ether bond and/or an ester bond,
R³ is a C₁₋₆ alkyl group, a C₇₋₁₂ aralkyl group, a C₄₋₈ cycloalkyl group, a C₆₋₁₄ aliphatic crosslinked ring group, or a C₆₋₁₄ aryl group,
in Formula (2),
W² is a C₁₋₆ alkyl group, a C₇₋₁₂ aralkyl group, a C₄₋₈ cycloalkyl group, a C₆₋₁₄ aliphatic crosslinked ring group, or a C₆₋₁₄ aryl group,
in Formula (3),
R² is a hydrogen atom or a methyl group,
L¹ is a C₁₋₃₀ divalent hydrocarbon group which arbitrarily contains an ether bond and/or an ester bond,
L² is *—NHC(═O)O—, *—C(═O)NH—, or *—C(═O)O— (* is a coupling end with respect to L¹), and
Z is an atomic group that exhibits nonlinear optical activity).

5. The nonlinear optically active copolymer-containing composition according to claim 4,
wherein W² is a C₁₋₃ alkyl group, a C₇₋₁₀ aralkyl group, a C₆₋₈ cycloalkyl group, a C₈₋₁₂ aliphatic crosslinked ring group, or a C₆₋₁₀ aryl group.

6. The nonlinear optically active copolymer-containing composition according to claim 4,
wherein L² is *—NHC(═O)O— (* is a coupling end with respect to L¹).

7. The nonlinear optically active copolymer-containing composition according to claim 4,
wherein Z is an atomic group having a furan ring group of Formula (4): 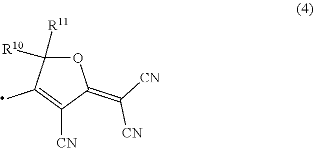
(wherein each of R¹⁰ and R¹¹ is independently a hydrogen atom, a C₁₋₅ alkyl group, a C₁₋₅ haloalkyl group, or a C₆₋₁₀ aryl group, and a black dot indicates a bond with the remaining structure constituting an atomic group Z that exhibits nonlinear optical activity).

8. The nonlinear optically active copolymer-containing composition according to claim 7,
wherein Z is an atomic group having a structure of Formula (5) or Formula (6) (in Formula (5) and Formula (6), one hydrogen atom is removed from any of R⁴ to R⁹): 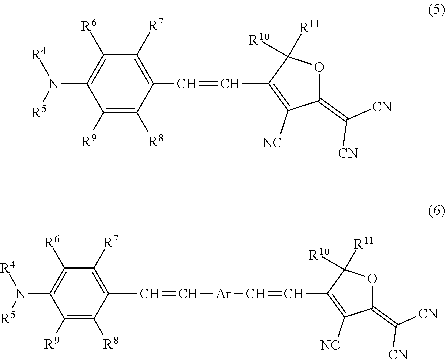
(wherein each of R⁴ and R⁵ is independently a hydrogen atom, a C₁₋₁₀ alkyl group which arbitrarily has a substituent, or a C₆₋₁₀ aryl group which arbitrarily has a substituent,
each of R⁶ to R⁹ is independently a hydrogen atom, a C₁₋₁₀ alkyl group, a hydroxy group, a C₁₋₁₀ alkoxy group, a C₂₋₁₁ alkylcarbonyloxy group, a C₄₋₁₀ aryloxy group, a C₅₋₁₁ arylcarbonyloxy group, a silyloxy group having a C₁₋₆ alkyl group and/or a phenyl group, or a halogen atom,
each of R¹⁰ and R¹¹ independently has the same meanings as defined above, and
Ar is a divalent aromatic group of Formula (7) or Formula (8)): 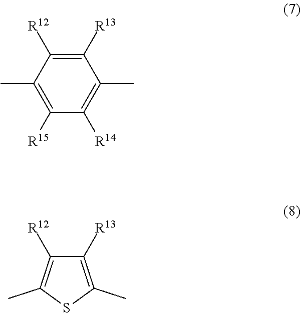
(wherein each of R¹² to R¹⁷ is independently a hydrogen atom, a C₁₋₁₀ alkyl group which arbitrarily has a substituent, or a C₆₋₁₀ aryl group which arbitrarily has a substituent).

9. The nonlinear optically active copolymer-containing composition according to claim 8,
wherein Z is an atomic group having a structure of Formula (5) or Formula (6) (in Formula (5) and Formula (6), one hydrogen atom is removed from either R⁴ or R⁵).

10. An electro-optic element comprising a thin film obtained from the nonlinear optically active copolymer-containing composition according to claim 1.
